(19) United States
(12) Patent Application Publication
(10) Pub. No.: US 2023/0086389 A1
(43) Pub. Date: Mar. 23, 2023

(54) OBJECT INFORMATION MANAGEMENT METHOD, APPARATUS AND DEVICE, AND STORAGE MEDIUM

(71) Applicant: SENSETIME INTERNATIONAL PTE. LTD., Singapore (SG)

(72) Inventor: Jinyi WU, Singapore (SG)

(21) Appl. No.: 17/489,976

(22) Filed: Sep. 30, 2021

Related U.S. Application Data
(63) Continuation of application No. PCT/IB2021/058771, filed on Sep. 27, 2021.

(30) Foreign Application Priority Data
Sep. 22, 2021 (SG) 10202110506Q

(51) Int. Cl. A63F 13/56; H04N 5/247; G06K 9/00

(52) U.S. Cl. CPC A63F 13/56; H04N 5/247; G06K 9/00624

(57) ABSTRACT

Provided are an object information management method, apparatus and device, and a storage medium. The method includes: acquiring, in response to an object state change event corresponding to a placement area, at least one object identifier that is obtained by detecting an object in the placement area by using a communication identification system; determining a first identification result based on the at least one object identifier and an object information mapping table, where the object information mapping table includes a mapping relationship between an object identifier and object information; acquiring a second identification result that is obtained by detecting the object in the placement area by using a visual identification system, where the second identification result includes second object information of the object in the placement area; and determining, based on the first object information and the second object information, real object information corresponding to the object state change event.

### CROSS-REFERENCE TO RELATED APPLICATION(S)

The application is continuation of international application PCT/IB2021/058771, filed on 27 Sep. 2021, which claims priority to Singaporean patent application No. 10202110506Q, filed with IPOS on 22 Sep. 2021. The contents of international application PCT/IB2021/058771 and Singaporean patent application No. 10202110506Q are incorporated herein by reference in their entireties.

### TECHNICAL FIELD

Embodiments of the disclosure relate to the field of data processing, and in particular, to an object information management method, apparatus and device, and a storage medium.

### BACKGROUND

In conventional technologies, in a process of detecting objects in a detection area, objects to be detected need to be laid out one by one, so that each object is identified by a detection system. This is relatively low in detection efficiency, and can hardly be applied to object information detection in complex scenarios.

### SUMMARY

Embodiments of the disclosure provide an object information management method, apparatus and device, and a storage medium.

According to a first aspect, an object information management method is provided, including:

acquiring, in response to an object state change event corresponding to a placement area, at least one object identifier that is obtained by detecting an object in the placement area by using a communication identification system;

determining a first identification result based on the at least one object identifier and an object information mapping table, where the object information mapping table includes a mapping relationship between an object identifier and object information, and the first identification result includes first object information of the object in the placement area;

acquiring a second identification result that is obtained by identifying the object in the placement area by using a visual identification system, where the second identification result includes second object information of the object in the placement area; and

determining, based on the first object information and the second object information, real object information corresponding to the object state change event.

In some embodiments, the first object information may include first subject information of a first holder of the object, and the second object information may include second subject information of a second holder of the object; and the determining, based on the first object information and the second object information, real object information corresponding to the object state change event may include:

comparing the first subject information with the second subject information, and determining a real holder of the object in the placement area based on a comparison result.

In some embodiments, the determining a real operator of the object in the placement area based on a comparison result may include:

if it is determined, based on the comparison result of the first subject information and the second subject information, that the first holder is the same as the second holder, determining that the real holder is the first holder or the second holder; or

if it is determined, based on the comparison result of the first subject information and the second subject information, that the first holder is different from the second holder, generating first warning information, where the first warning information is used to indicate that a holder of the object in the placement area is abnormal; and

receiving a first feedback message for the first warning information, and parsing the first feedback message to determine the real holder, where the first feedback message carries manually specified subject information of the real holder of the object in the placement area.

In the embodiments of the disclosure, since the first subject information identified by the communication identification system is compared with the second subject information identified by the visual identification system, cross verification for the holder of the object in the placement area is implemented, and the accuracy of determining the holder of the object in the placement area is improved. In addition, if it is determined that the identification results of the communication identification system and the visual identification system are different, the first warning information is generated, so that an abnormality in a current scenario can be fed back to a manager in time, thereby improving the security of object information management. Furthermore, because the first feedback message for the first warning information is received, if the identification results of the communication identification system and the visual identification system are different, an accurate identification result may still be obtained through manual intervention, thereby further improving the accuracy of determining the holder of the object in the placement area.

In some embodiments, the first object information may include first value information of the object, and the second object information includes second value information of the object.

The determining, based on the first object information and the second object information, real object information corresponding to the object state change event may include:

comparing the first value information with the second value information of the object in the placement area, and determining real value information of the object in the placement area based on a comparison result.

In some embodiments, the determining real value information of the object in the placement area based on a comparison result may include:

if the first value information and the second value information of the object in the placement area are the same, determining that the real value information of the object in the placement area is the first value information or the second value information; or

if the first value information and the second value information of the object in the placement area are different, generating second warning information, where the second warning information is used to indicate that value information of the object in the placement area is abnormal and/or the second warning information is used to request to manually adjust the object in the placement area.

In the embodiments of the disclosure, since the first value information identified by the communication identification system is compared with the second value information identified by the visual identification system, cross verification for a value of the object in the placement area is implemented, and the accuracy of determining the value of the object in the placement area is improved. In addition, if it is determined that the identification results of the communication identification system and the visual identification system are different, the second warning information is generated, so that an abnormality in a current scenario can be fed back to a manager in time, thereby improving the security of object information management. Furthermore, because the second feedback message for the second warning information is received, if the identification results of the communication identification system and the visual identification system are different, an accurate identification result may still be obtained through manual intervention, thereby further improving the accuracy of determining the value of the object in the placement area.

In some embodiments, the placement area may include a prop placement area of a game.

The method may further include:

if it is determined that the game generates a game result, determining an area state corresponding to the prop placement area, where the area state is used to represent a game result of a game party corresponding to the prop placement area.

The determining, based on the first object information and the second object information, real object information corresponding to the object state change event may include:

determining the real object information corresponding to the object state change event based on the area state of the prop placement area, the first object information, and the second object information.

In some embodiments, the determining, based on the area state of the prop placement area, the first object information, and the second object information, the real object information corresponding to the object state change event may include:

if the area state of the prop placement area is a first state, deleting a mapping relationship between the at least one object identifier and a corresponding holder from the object information mapping table, where the first state represents that the game result of the game party corresponding to the prop placement area is a failure; or

if the area state of the prop placement area is a second state, establishing the mapping relationship between the at least one object identifier and the corresponding holder in the object information mapping table, where the second state represents that the game result of the game party corresponding to the prop placement area is a victory.

In some embodiments, the method may further include:

acquiring a game result of the game by identifying a game prop on a game table based on the visual identification system, where the game table includes a plurality of prop placement areas, and the game result includes an area state corresponding to each of the prop placement areas.

By means of the foregoing embodiments of the disclosure, an area state of a current placement area can be quickly obtained based on the visual identification system, and different object information management operations are performed on an object in the placement area for different area states, thereby improving not only object information management efficiency but also management flexibility. In addition, if the area state is the first state, a holder corresponding to an object is removed from the object information mapping table in time, so that fast retrieval of the current placement area can be implemented. Even if the object in the current placement area is illegally occupied, the illegally occupied object may be identified in a case that there is no holder corresponding to the object in the object information mapping table. In addition, if the area state is the second state, a mapping relationship between the at least one object identifier and the second holder is established in the object information mapping table in time, so that the object can be rapidly distributed to the corresponding holder based on a game result; and a mapping relationship between an object and a holder is established, thereby indirectly improving object distribution efficiency.

In some embodiments, the visual identification system may include a first image capturing device located above the placement area and a second image capturing device located on a side of the placement area, and the second identification result may be obtained by:

acquiring a plurality of image frames corresponding to the object state change event, where the plurality of image frames includes at least one top-view image frame of the placement area that is captured by the first image capturing device and at least one side-view image frame of the placement area that is captured by the second image capturing device; and

identifying the object in the placement area in the plurality of image frames by using the visual identification system, to obtain the second object information.

In some embodiments, if the second object information includes second value information of the object, the identifying the object in the placement area in the plurality of image frames by using the visual identification system, to obtain the second object information may include:

acquiring a side image of the object in the placement area based on the at least one side-view image frame; and

determining the second value information of the object based on the side image of the object in the placement area.

In some embodiments, if the second object information includes second subject information of a second holder of the object, the identifying the object in the placement area in the plurality of image frames by using the visual identification system, to obtain the second object information may include:

determining an associated image frame from the at least one top-view image frame, where the associated image frame includes an intervening part that has an association relationship with the object in the placement area;

determining a target image frame corresponding to the associated image frame from the at least one side-view image frame, where the target image frame includes the intervening part that has an association relationship with the object in the placement area, and at least one intervener; and

determining the second subject information of the second holder from the at least one intervener based on the associated image frame and the target image frame.

By means of the foregoing embodiments of the disclosure, an intervening part that has the highest degree of association with an object may be obtained in a bird's eye angle. Because location information in the bird's eye angle is proportional to actual location information, a location relationship between the object and the intervening part obtained in the bird's eye angle is more accurate than that in a side-view angle. Further, an associated image frame is combined with a corresponding side-view image frame, to implement determination from the object to the intervening part that has the highest degree of association with the object (determination based on the associated image frame), and to further implement determination from the intervening part that has the highest degree of association with the object to the second subject information of the second holder (determination based on the corresponding side-view image frame). Thus, the second subject information of the second holder that has the highest degree of association with the object is determined, thereby improving the accuracy of determining the second subject information.

According to a second aspect, an object information management apparatus is provided, including:

a first identification module, configured to acquire, in response to an object state change event corresponding to a placement area, at least one object identifier that is obtained by detecting an object in the placement area by using a communication identification system;

a first determination module, configured to determine a first identification result based on the at least one object identifier and an object information mapping table, where the object information mapping table includes a mapping relationship between an object identifier and object information, and the first identification result includes first object information of the object in the placement area;

a second identification module, configured to acquire a second identification result that is obtained by identifying the object in the placement area by using a visual identification system, where the second identification result includes second object information of the object in the placement area; and

a second determination module, configured to determine, based on the first object information and the second object information, real object information corresponding to the object state change event.

According to a third aspect, an object information management device is provided, including a memory and a processor. The memory stores a computer program capable of running on the processor, and when the processor executes the computer program, the steps in the foregoing method are implemented.

According to a fourth aspect, a computer storage medium is provided. The computer storage medium stores one or more programs, and the one or more programs can be executed by one or more processors to implement the steps in the foregoing method.

In the embodiments of the disclosure, since an object in a current placement area is detected by using both a communication identification system and a visual identification system, the accuracy of acquiring object information in the current placement area can be improved. In addition, because different identification systems are employed to detect the object in the current placement area, if the different identification systems have different identification defects, the integrity of the object information can be improved by combining identification results of the different identification systems. Because the object in the current placement area is detected by using both the communication identification system and the visual identification system, accurate object information can be obtained in a complex scenario such as occlusion between objects, thereby improving the application scope of the object information management method.

### BRIEF DESCRIPTION OF THE DRAWINGS

FIG. 1 is a schematic diagram of an object information management scenario according to an embodiment of the disclosure.

FIG. 2 is a schematic flowchart of an object information management method according to an embodiment of the disclosure.

FIG. 3 is a schematic flowchart of an object information management method according to an embodiment of the disclosure.

FIG. 4 is a schematic flowchart of an object information management method according to an embodiment of the disclosure.

FIG. 5 is a schematic flowchart of an object information management method according to an embodiment of the disclosure.

FIG. 6 is a schematic flowchart of an object information management method according to an embodiment of the disclosure.

FIG. 7 is a schematic flowchart of an object information management method according to another embodiment of the disclosure.

FIG. 8 is a schematic flowchart of an object information management method according to another embodiment of the disclosure.

FIG. 9 is a schematic structural diagram of composition of an object information management apparatus according to an embodiment of the disclosure.

FIG. 10 is a schematic diagram of a hardware entity of an object information management device according to an embodiment of the disclosure.

### DETAILED DESCRIPTION

The following describes the disclosure in detail through embodiments with reference to the accompanying drawings. The following several specific embodiments may be combined with each other, and the same or similar concepts or processes may not be described repeatedly in some embodiments.

It is to be noted that in the embodiments of the disclosure, “first”, “second”, and the like are intended to distinguish between similar subjects but do not necessarily describe the order or sequence of targets. In addition, if no conflict occurs, the embodiments of the disclosure can be arbitrarily combined.

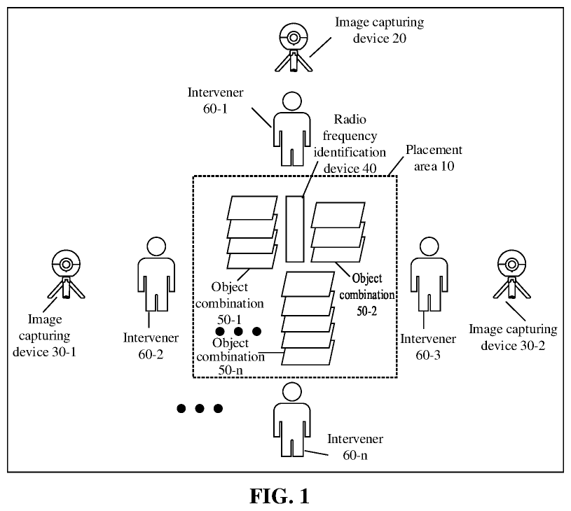

An embodiment of the disclosure provides an object information identification scenario. As shown in FIG. 1, FIG. 1 is a schematic diagram of an object information management scenario according to an embodiment of the disclosure. The object information management scenario includes: an image capturing device 20 located above a placement area 10, and configured to perform image capturing on the placement area at a vertical angle in practical applications; and an image capturing device 30 (an image capturing device 30-1 and an image capturing device 30-2 are exemplified in the figure) located on a side of the placement area 10, and configured to perform image capturing on the placement area at a parallel angle in practical applications. The image capturing device 20, the image capturing device 30-1, and the image capturing device 30-2 continuously detect the placement area 10 based on respective orientations and angles. A corresponding radio frequency identification device 40 is further disposed in the placement area 10. At least one of object combinations 50-1 to 50-n is disposed in the placement area 10, and any one of the object combinations 50-1 to 50-n is formed by stacking at least one object. The placement area 10 includes at least one intervener 60-1 to 60-n, and the interveners 60-1 to 60-n are within capturing ranges of the image capturing device 20, the image capturing device 30-1, and the image capturing device 30-2. In the image identification scenario provided in the embodiments of the disclosure, the image capturing device may be a camera lens, a camera, or the like, the intervener may be a character, and the object may be a stackable object. When one of characters 60-1 to 60-n takes or places an object from or in the placement area 10, the camera 20 may capture an image of the character extending a hand into the placement area 10 at a top vertical viewing angle, and a camera 30-1 and a camera 30-2 may capture images of the corresponding characters 60-1 to 60-n at different side viewing angles.

In the embodiments of the disclosure, the image capturing device 20 is generally disposed above the placement area 10, for example, directly above or in the vicinity directly above a center point of the placement area, and a capturing range thereof covers at least the entire placement area. The image capturing devices 30-1 and 30-2 are located on sides of the placement area and respectively disposed on two opposite sides of the placement area, and are flush with an object in the placement area in respect of setting height, and capturing ranges thereof cover the entire placement area and an intervener around the placement area.

In some embodiments, when the placement area is a square area on a table top, the image capturing device 20 may be disposed directly above a center point of the square area, and a setting height thereof may be adjusted based on a specific viewing angle of the image capturing device, to ensure that the capturing range can cover a square area of the entire placement area. The image capturing devices 30-1 and 30-2 are respectively disposed on the two opposite sides of the placement area, and may be flush with object combinations 50-1 to 50-n in the placement area in respect of setting height, and distances from the placement area may be adjusted based on specific viewing angles of the image capturing devices, to ensure that the capturing ranges can cover the entire placement area and the intervener around the placement area.

In some embodiments, a visual identification system includes at least the image capturing device 20 and the image capturing device 30, and a communication identification system includes at least a plurality of radio frequency identification devices 40 corresponding to a plurality of placement areas 10.

It is to be noted that, in actual use, in addition to the image capturing devices 30-1 and 30-2, more image capturing devices located on the sides of the placement area may be provided as required. This is not limited in the embodiments of the disclosure.

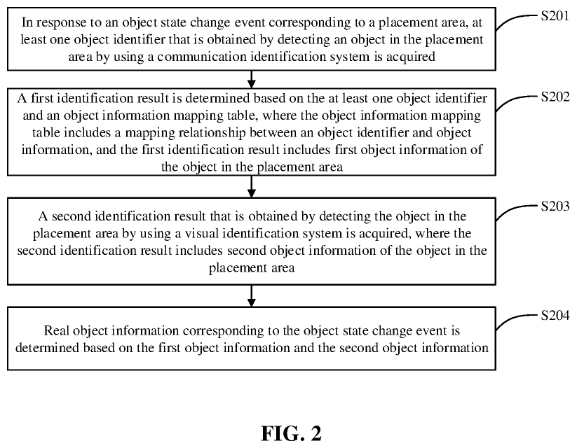

FIG. 2 is a schematic flowchart of an object information management method according to an embodiment of the disclosure. As shown in FIG. 2, the method is applied to an object information management system, and the method includes the following steps.

At S201, in response to an object state change event corresponding to a placement area, at least one object identifier that is obtained by detecting an object in the placement area by using a communication identification system is acquired.

In some embodiments, the object state change event corresponding to the placement area is generated in a case that the state of the object in the placement area changes. The object state change event may be generated based on an identification result after detecting an object state of the object in the placement area by using a communication identification system and a visual identification system in the embodiments of the disclosure, or may be generated in response to a change instruction after receiving the change instruction used to represent a change of the object state. This is not limited in the embodiments of the disclosure. The object state may include the quantity of objects, a location of an object, a relative location between a plurality of objects, and the like.

In some embodiments, the communication identification system may include a plurality of communications devices. For a placement area in a current scenario, the communication identification system may configure at least one communications device for the placement area, and the at least one communications device is configured to detect an object in the placement area to obtain at least one object identifier.

It is to be noted that the communication identification system may receive a radio frequency signal sent by at least one object in the placement area, and parse the radio frequency signal to acquire the object identifier of each object. The radio frequency signal may be any one of the following signals: a Near Field Communication (NFC) signal, a Radio Frequency Identification (RFID) signal, a Bluetooth signal, or an infrared signal.

At S202, a first identification result is determined based on the at least one object identifier and an object information mapping table, where the object information mapping table includes a mapping relationship between an object identifier and object information, and the first identification result includes first object information of the object in the placement area.

In some embodiments, the object information mapping table includes a preset mapping relationship between each of a plurality of object identifiers and corresponding object information. Based on an object identifier corresponding to each object in the placement area that is acquired by the communication identification system, object information corresponding to each object is acquired from the object information mapping table, to obtain the first object information.

It is to be noted that the object in the placement area may be one object subject, or may be a plurality of object subjects. If the object is one object subject, the first object information includes only object information corresponding to this object subject in the object information mapping table. If the object is a plurality of object subjects, the first object information includes object information corresponding to each object subject in the object information mapping table.

In some embodiments, the object information may include at least one of the following information: a holder of the object, a name of the object, a value of the object, a category of the object, and the like.

At S203, a second identification result that is obtained by identifying the object in the placement area by using a visual identification system is acquired, where the second identification result includes second object information of the object in the placement area.

In some embodiments, the visual identification system is configured to: acquire at least one image frame of the placement area, and detect and identify the object in the placement area based on the at least one image frame, to obtain the second identification result. The second identification result includes the second object information that is obtained by detecting the object in the placement area by the visual identification system.

If the object is one object subject, the second object information includes only second object information corresponding to this object subject. If the object is a plurality of object subjects, the second object information includes second object information corresponding to each object subject.

At S204, real object information corresponding to the object state change event is determined based on the first object information and the second object information.

The first object information and the second object information may be fused to obtain the real object information of the object. Fusion may be implemented by superimposing the first object information and the second object information. In an embodiment, one of the first object information and the second object information may be selected as the real object information based on a comparison of credibility of the first object information and the second object information, where the credibility of the first object information and the second object information may be related to methods for acquiring the first object information and the second object information.

In some embodiments, S204 may be implemented in the following implementations:

(1) If an information type of the first object information obtained by the visual identification system is different from an information type of the second object information obtained by the communication identification system, a first object quantity and/or a first object location of the object in the placement area are/is determined based on the first object information; and a second object quantity and/or a second object location of the object in the placement area are/is determined based on the second object information. If the first object quantity is the same as the second object quantity, and/or the first object location is the same as the second object location, the first object information and the second object information are fused, to obtain fused object information of a real object corresponding to the object state change event. For example, if it is determined that the first object information obtained by using the visual identification system includes two types of information: an object name of the object and an object value of the object, the second object information obtained by using the communication identification system includes two types of information: subject information of a holder of the object and an object attribute of the object. If it is determined that the first object quantity is the same as the second object quantity, it is considered that the two identification systems accurately detect the object in the current placement area, and the object information obtained by the two identification systems may be combined to obtain object information including four object attributes.

(2) If an information type of the first object information obtained by the visual identification system is the same as an information type of the second object information obtained by the communication identification system, the second object information may be verified based on the first object information, and correspondingly, the first object information may be verified based on the second object information. If the first object information is the same as the second object information, that is, verification succeeds, the first object information or the second object information is determined as the real object information in the current placement area.

In the embodiments of the disclosure, since an object in a current placement area is detected by using both a communication identification system and a visual identification system, the accuracy of acquiring object information in the current placement area can be improved. In addition, because different identification systems are employed to detect the object in the current placement area, if the different identification systems have different identification defects, the integrity of the object information can be improved by combining identification results of the different identification systems. Because the object in the current placement area is detected by using both the communication identification system and the visual identification system, accurate object information can be obtained in a complex scenario such as occlusion between objects, thereby improving the application scope of the object information management method.

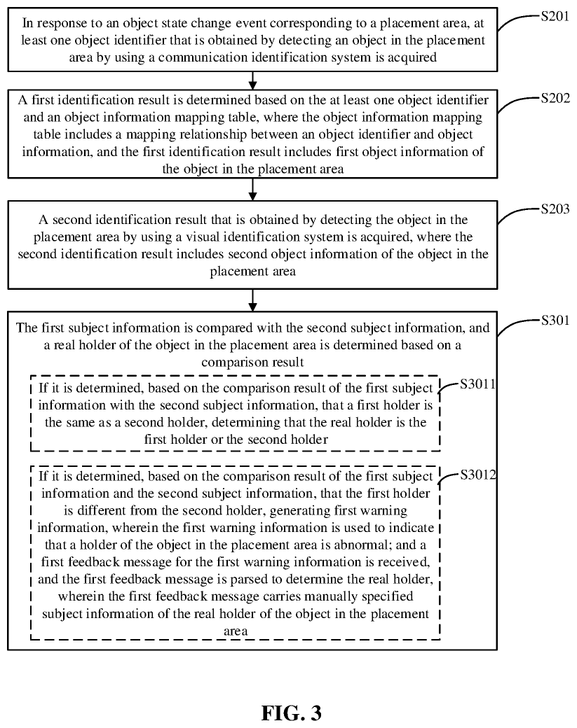

Referring to FIG. 3, FIG. 3 is a schematic flowchart of an object information management method according to an embodiment of the disclosure. Based on FIG. 2, S204 in FIG. 2 may be updated to S301, which is described with reference to the steps shown in FIG. 3.

At S301, the first subject information is compared with the second subject information, and a real holder of the object in the placement area is determined based on a comparison result.

In some embodiments, a plurality of object subjects in the current area may correspond to one holder, or may correspond to a plurality of holders. If the plurality of object subjects in the current area correspond to one holder, the plurality of object subjects may be combined into one object. If the plurality of object subjects in the current area correspond to a plurality of holders, an object subject corresponding to each holder may be formed into one object, that is, the plurality of object subjects may be combined into a plurality of objects, and each object corresponds to one holder. For ease of understanding of the embodiments of the disclosure, each object in the embodiments of the disclosure corresponds to one holder.

In some embodiments, the first object information generated based on the communication identification system includes first subject information of a first holder of the object in the placement area. The second object information generated based on the visual identification system includes second subject information of a second holder of the object in the placement area. The first subject information may include identity information of the first holder, and the second subject information may include identity information of the second holder. The identity information may be an identity mark, or may be a face image or a face feature.

In some embodiments, the first holder may be compared with the second holder by using steps S3011 and S3012, to determine the real holder.

At S3011, if it is determined, based on the comparison result of the first subject information and the second subject information, that the first holder is the same as the second holder, it is determined that the real holder is the first holder or the second holder.

For example, if a first identification result obtained by the communication identification system represents that the first subject information detected by the communication identification system is a user identity mark A, and a second identification result obtained by the visual identification system represents that the second subject information detected by the visual identification system is also the user identity mark A, the real holder is set to a user whose identity mark is A.

At S3012, if it is determined, based on the comparison result of the first subject information and the second subject information, that the first holder is different from the second holder, first warning information is generated, where the first warning information is used to indicate that a holder of the object in the placement area is abnormal; and a first feedback message for the first warning information is received, and the first feedback message is parsed to determine the real holder, where the first feedback message carries manually specified subject information of the real holder of the object in the placement area.

For example, if a first identification result obtained by the communication identification system represents that the first holder that can be detected by the communication identification system is a user A, and a second identification result obtained by the visual identification system represents that the second holder that can be detected by the visual identification system is a user B, the first warning information is generated, where the first warning information is used to indicate that the holder in the placement area is abnormal.

In some embodiments, the first warning information may be presented by at least one presentation device. The at least one presentation device includes a display device. If the presentation device is a display device, the first warning information may be displayed by the display device. In addition, a touch option corresponding to the first holder and a touch option corresponding to the second holder may also be displayed based on the display device. A trigger operation performed by a manager on a target touch option in the touch option corresponding to the first holder and the touch option corresponding to the second holder is received, and the first feedback message for the first warning information is generated, where the first feedback message carries the manually specified subject information of the real holder of the object in the placement area. The first feedback message is sent to an object information management system, and the first feedback message is parsed to determine the real holder.

In the embodiments of the disclosure, since the first subject information identified by the communication identification system is compared with the second subject information identified by the visual identification system, cross verification for the holder of the object in the placement area is implemented, and the accuracy of determining the holder of the object in the placement area is improved. In addition, if it is determined that the identification results of the communication identification system and the visual identification system are different, the first warning information is generated, so that an abnormality in a current scenario can be fed back to a manager in time, thereby improving the security of object information management. Furthermore, because the first feedback message for the first warning information is received, if the identification results of the communication identification system and the visual identification system are different, an accurate identification result may still be obtained through manual intervention, thereby further improving the accuracy of determining the holder of the object in the placement area.

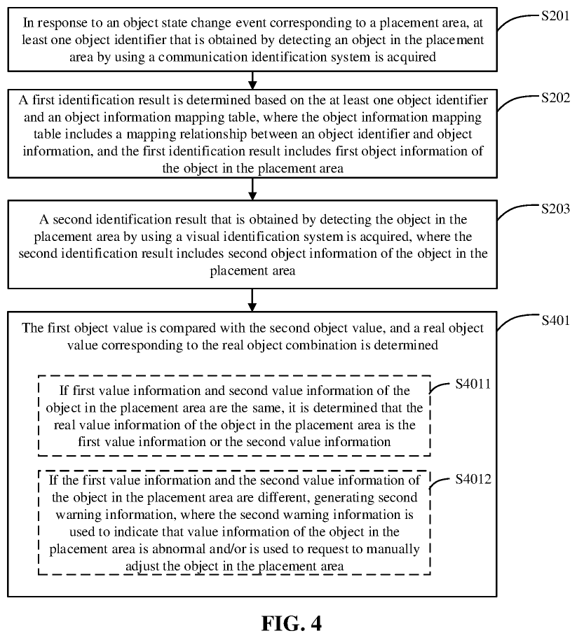

Referring to FIG. 4, FIG. 4 is a schematic flowchart of an object information management method according to an embodiment of the disclosure. Based on FIG. 2, S204 in FIG. 2 may be updated to S401 to S402, which are described with reference to the steps shown in FIG. 4.

At S401, the first value information is compared with the second value information to determine the real value information.

In some embodiments, value information that an object in the current area may correspond to may be a value sum of sub-value information of each object subject corresponding to the object. For example, if a first object includes an object subject X1, an object subject X2, and an object subject X3, and sub-value information respectively corresponding to the object subject X1, the object subject X2, and the object subject X3 is 20, 20, and 50, the first value information is “90”.

In some embodiments, value information that an object in the current area may correspond to may be statistical information of each piece of sub-value information in the object. For example, based on the foregoing example, if the first object includes an object subject X1, an object subject X2, and an object subject X3, and the sub-value information respectively corresponding to the object subject X1, the object subject X2, and the object subject X3 is 20, 20, and 50, the first value information is “(20, 2), (50, 1)”.

It is to be noted that the object value that the object in the current area may correspond to may be embodied in other forms, and is not limited to the foregoing two implementations.

In some embodiments, the first value information may be compared with the second value information by using steps S4011 and S4012, to determine the real value information.

At S4011, if the first value information and the second value information of the object in the placement area are the same, it is determined that the real value information of the object in the placement area is the first value information or the second value information.

For example, if a first identification result obtained by the communication identification system represents that the first value information that can be detected by the communication identification system is “90”, and a second identification result obtained by the visual identification system represents that the second value information that can be detected by the visual identification system is also “90”, the real value information is set to “90”.

For another example, if a first identification result obtained by the communication identification system represents that the first value information that can be detected by the communication identification system is “(20, 2), (50, 1)”, and a second identification result obtained by the visual identification system represents that the second value information that can be detected by the visual identification system is also “(20, 2), (50, 1)”, the real value information is set to “(20, 2), (50, 1)”.

At S4012, if the first value information and the second value information of the object in the placement area are different, second warning information is generated, where the second warning information is used to indicate that value information of the object in the placement area is abnormal and/or is used to request to manually adjust the object in the placement area.

For example, if a first identification result obtained by the communication identification system represents that the first value information that can be detected by the communication identification system is “90”, and a second identification result obtained by the visual identification system represents that the second value information that can be detected by the visual identification system is “80”, the second warning information is generated, where the second warning information is used to indicate that the object value of the object in the placement area is abnormal and/or is used to request to manually adjust the object in the placement area.

For another example, if a first identification result obtained by the communication identification system represents that the first value information that can be detected by the communication identification system is “(20, 2), (50, 1)”, and a second identification result obtained by the visual identification system represents that the second value information that can be detected by the visual identification system is also “(20, 1), (50, 1), (60, 1)” or “(10, 4), (50, 1)”, the second warning information is generated, where the second warning information is used to indicate that the object value of the object in the placement area is abnormal and/or is used to request to manually adjust the object in the placement area.

In some embodiments, an obstructing relationship between objects in the current placement area affects identification effects of the communication identification system and/or the visual identification system. Therefore, the manager needs to manually adjust the object in the placement area, and after the adjustment is completed, an adjusted first identification result and an adjusted second identification result, i.e., updated first value information and updated second value information can be obtained.

In some embodiments, the method further includes: detecting the object in the placement area again by using the communication identification system and/or the visual identification system, and determining the real value information based on the updated first value information and the updated second value information.

If the updated first value information is the same as the updated second value information, it is determined that the real value information is the updated first value information or the updated second value information; or if the updated first value information is different from the updated second value information, a second feedback message for the second warning information is received, and the second feedback message is parsed to obtain the real value information.

In some other embodiments, the first value information may be compared with the second value information in the following implementation, to determine the real value information. If the first value information is different from the second value information, second warning information is generated, where the second warning information is used to indicate that a value of the object in the placement area is abnormal; and a second feedback message for the second warning information is received, and the second feedback message is parsed to obtain the real value information.

The second warning information may be presented by at least one presentation device. The at least one presentation device includes a display device. If the presentation device is a display device, the second warning information may be displayed by the display device. In addition, a touch option corresponding to the first value information and a touch option corresponding to the second value information may also be displayed based on the display device. A trigger operation performed by a manager on a target touch option in the touch option corresponding to the first value information and the touch option corresponding to the second value information is received, the second feedback message for the second warning information is generated, the second feedback message is sent to an object information management system, and the second feedback message is parsed to obtain the real value information.

In the embodiments of the disclosure, since the first value information identified by the communication identification system is compared with the second value information identified by the visual identification system, cross verification for a value of the object in the placement area is implemented, and the accuracy of determining the value of the object in the placement area is improved. In addition, if it is determined that the identification results of the communication identification system and the visual identification system are different, the second warning information is generated, so that an abnormality in a current scenario can be fed back to a manager in time, thereby improving the security of object information management. Furthermore, because the second feedback message for the second warning information is received, if the identification results of the communication identification system and the visual identification system are different, an accurate identification result may still be obtained through manual intervention, thereby further improving the accuracy of determining the value of the object in the placement area.

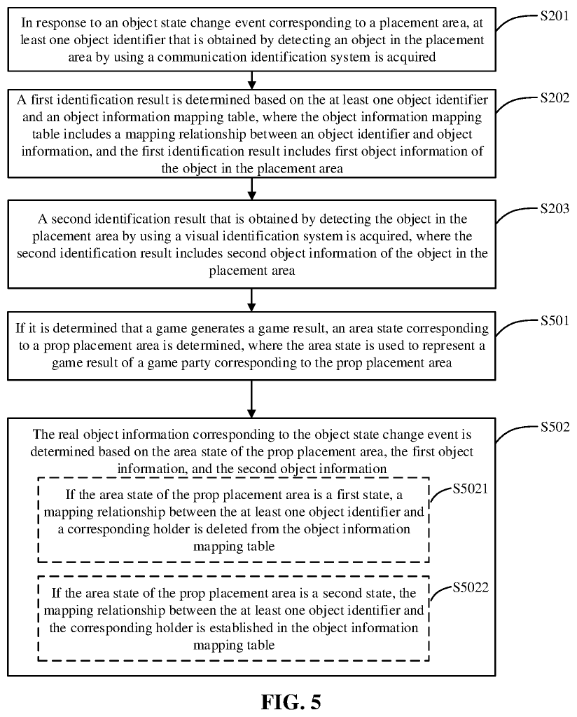

Referring to FIG. 5, FIG. 5 is a schematic flowchart of an object information management method according to an embodiment of the disclosure. Based on FIG. 2, the method in FIG. 2 further includes S501, and S204 may be updated to S502, which is described with reference to the steps shown in FIG. 5. The foregoing placement area is a prop placement area of a game.

At S501, if it is determined that the game generates a game result, an area state corresponding to the prop placement area is determined, where the area state is used to represent a game result of a game party corresponding to the prop placement area.

In some embodiments, the area state includes a first state and a second state. The first state represents that the game result of the game party corresponding to the prop placement area is a failure. If the area state of the placement area is the first state, the object in the placement area needs to be retrieved, that is, an object subject in the placement area no longer has a holder. The second state represents that the game result of the game party corresponding to the prop placement area is a victory. If the placement area is in the second state, a new object needs to be distributed to the placement area, that is, a holder corresponding to the placement area may also hold the new object in the placement area.

The method further includes: acquiring a game result of the game by identifying game props on a game table based on the visual identification system, where the game table includes a plurality of prop placement areas, and the game result includes an area state corresponding to each of the prop placement areas.

At S502, the real object information corresponding to the object state change event is determined based on the area state of the prop placement area, the first object information, and the second object information.

In some embodiments, the real object information corresponding to the object state change event may be determined based on the area state of the prop placement area, the first object information, and the second object information by using steps S5021 and S5022.

At S5021, if the area state of the prop placement area is a first state, a mapping relationship between the at least one object identifier and a corresponding holder is deleted from the object information mapping table.

If the area state of the prop placement area is the first state, the game result of the game party corresponding to the prop placement area is a failure, and a corresponding object in a placement area of the game party needs to be retrieved. Therefore, the mapping relationship between the at least one object identifier and the corresponding holder (i.e., the game party) needs to be deleted from the object information mapping table.

At S5022, if the area state of the prop placement area is a second state, the mapping relationship between the at least one object identifier and the corresponding holder is established in the object information mapping table.

If the area state of the prop placement area is the second state, the game result of the game party corresponding to the prop placement area is a victory, a corresponding object in a placement area of the game party does not need to be retrieved, and a new object further needs to be distributed to the game party in the placement area. Therefore, the mapping relationship between the at least one object identifier and the corresponding holder (i.e., the game party) needs to be established in the object information mapping table.

By means of the foregoing embodiments of the disclosure, the area state of the current placement area can be quickly obtained based on the visual identification system, and different object information management operations are performed on the object in the placement area for different area states, thereby improving not only object information management efficiency but also management flexibility. In addition, if the area state is the first state, a holder corresponding to an object is removed from the object information mapping table in time, so that fast retrieval of the current placement area can be implemented. Even if the object in the current placement area is illegally occupied, the illegally occupied object may be identified in a case that there is no holder corresponding to the object in the object information mapping table. In addition, if the area state is the second state, a mapping relationship between the at least one object identifier and the second holder is established in the object information mapping table in time, so that the object can be rapidly distributed to the corresponding holder based on a game result; and a mapping relationship between an object and a holder is established, thereby indirectly improving object distribution efficiency.

Referring to FIG. 6, FIG. 6 is a schematic flowchart of an object information management method according to an embodiment of the disclosure. Based on any one of the foregoing embodiments, taking FIG. 2 as an example, S203 in FIG. 2 may further include S601 to S603, which are described with reference to the steps shown in FIG. 6.

At S601, a plurality of image frames corresponding to the object state change event is acquired, where the plurality of image frames includes at least one top-view image frame of the placement area that is captured by the first image capturing device and at least one side-view image frame of the placement area that is captured by the second image capturing device.

At S602, the object in the placement area in the plurality of image frames is identified by using the visual identification system, to obtain the second object information.

In some embodiments, if the second object information includes second value information, the plurality of image frames may be identified by the visual identification system by using 56021 to 56022, to obtain the second object information.

At 56021, a side image of the object in the placement area is acquired based on the at least one side-view image frame.

At 56022, the second value information of the object is determined based on the side image of the object in the placement area.

In some embodiments, the second value information is a sum of value information of each object subject in at least one object subject constituting the object; and the side image includes a side image of the at least one object subject, and a side image of each object subject may represent value information corresponding to the side image.

In some embodiments, if the second object information includes a second holder, the plurality of image frames may be identified by the visual identification system by using 56023 to S6025, to obtain the second object information.

At 56023, an associated image frame is determined from the at least one top-view image frame, where the associated image frame includes an intervening part that has an association relationship with the object in the placement area.

At 56024, a target image frame corresponding to the associated image frame is determined from the at least one side-view image frame, where the target image frame includes the intervening part that has an association relationship with the object in the placement area, and at least one intervener.

At S6025, the second subject information of the second holder is determined from the at least one intervener based on the associated image frame and the target image frame.

By means of the foregoing embodiments of the disclosure, an intervening part that has the highest degree of association with an object may be obtained in a bird's eye angle. Because location information in the bird's eye angle is proportional to actual location information, a location relationship between the object and the intervening part obtained in the bird's eye angle is more accurate than that in a side-view angle. Further, an associated image frame is combined with a corresponding side-view image frame, to implement determination from the object to the intervening part that has the highest degree of association with the object (determination based on the associated image frame), and to further implement determination from the intervening part that has the highest degree of association with the object to the second subject information of the second holder (determination based on the corresponding side-view image frame). Thus, the second subject information of the second holder that has the highest degree of association with the object is determined, thereby improving the accuracy of determining the second subject information.

The following describes an example in which this embodiment of the disclosure is applied to an actual casino scenario.

A smart casino monitoring system uses either RFID information or visual information of a camera alone when counting a betting record of a player. Many pieces of information are missing in the two schemes, resulting in poor flexibility of these schemes. If only the RFID information is used, a system imposes many restrictions on a betting mode of the player. A player in a seat is usually required to perform betting in a preset betting area. If only the visual information is used, excessive chips (corresponding to objects in the foregoing embodiments) on a table top cannot be processed, and visual occlusion exists between stacks of chips. Due to the foregoing restrictions, recording is not accurate in an existing monitoring system in a specific scenario.

In an actual smart casino scenario, many pieces of information are required to implement a player betting recording function, including information about an association between a player identity and chips and chip identification information. If only the RFID is used, the player identity can only be bound to the betting area. As a result, a casino process is inflexible, and too many requirements are imposed on a player, which is not conducive to increasing revenue. If only a camera is used, although the association between the player identity and the chips and chip identification can be completed, the accuracy of player betting recording is significantly reduced due to a visual restriction when there are many people or occlusion exists because of a large quantity of chips on a table.

In view of the above, the player betting recording function is compatible with various complex casino situations. In the embodiments of the disclosure, the combination of RFID and a camera is used. An ownership of chips is tracked when the chips are sold, to ensure the accuracy of the player betting recording function. In addition, RFID of a chip value is also more accurate than visual identification and can adapt to various situations, thereby further improving the accuracy of this embodiment of the disclosure. In the embodiments of the disclosure, face information, chip location information, and the like that are captured by a camera system are also used to further verify betting information obtained through RFID, and manual verification is performed when the two are inconsistent. This cross-verification method enables the accuracy of a betting record to finally reach 99% or more.

In some embodiments, in a process of selling an object (object combination) to a player subject, face recognition is performed on the player subject to obtain face information of the player subject, and a mapping relationship between the object (object combination) and the player subject is stored.

In a process of selling an object such as a chip to a player, face information of a player subject may be acquired by using an image acquiring apparatus disposed in a device (such as a counter) for selling an object (object combination), an identity of the player subject in a customer management system is acquired based on the face information, the currently sold object (object combination) is associated with the identity of the player subject, and a management relationship is stored in an object management system (corresponding to the object information mapping table in the foregoing embodiments).

In some embodiments, the embodiments of the disclosure may be applied to a betting stage in a game. A corresponding radio frequency identification system and a visual identification system are disposed in all game tables/object placement tables in a current amusement park. The radio frequency identification system is configured to detect a target object in any betting area on the game table/object placement table, to obtain an object identifier of the target object in the betting area. In the device identification system, a corresponding radio frequency identification device is provided for each betting area. The visual identification system is configured to detect a player in a current game scenario and a target object in any betting area on the game table/object placement table, to obtain a holder and value information corresponding to the target object in the betting area.

In the betting of the game, after a player performs betting, that is, after at least one target object is placed in a betting area (corresponding to the placement area in the foregoing embodiments), an object in the betting area may be detected by using a radio frequency device corresponding to the betting area, to obtain an object identifier of each of the at least one target object. Object information corresponding to each target object is obtained with reference to an association relationship between the object identifier and the object information that is stored in the object management system. The object information may include value information and holder information corresponding to the object. In addition, a plurality of video frames corresponding to the betting process of the player may be further detected by using the foregoing visual identification system, to obtain a holder corresponding to the at least one target object in the betting area or value information of the at least one target object in the betting area.

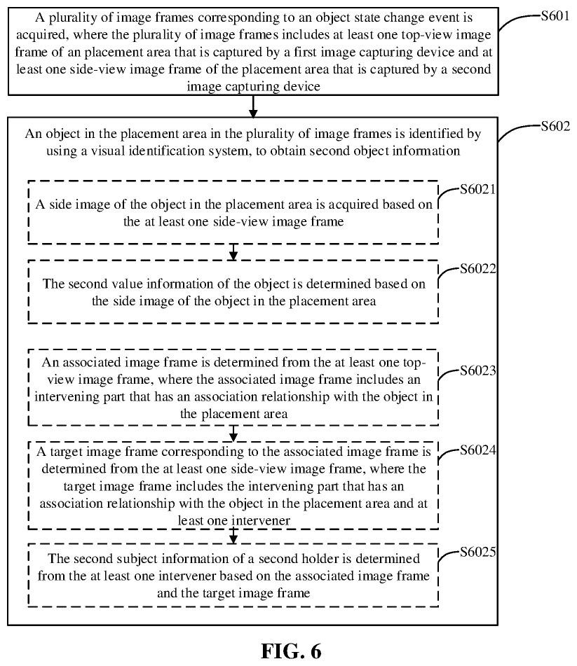

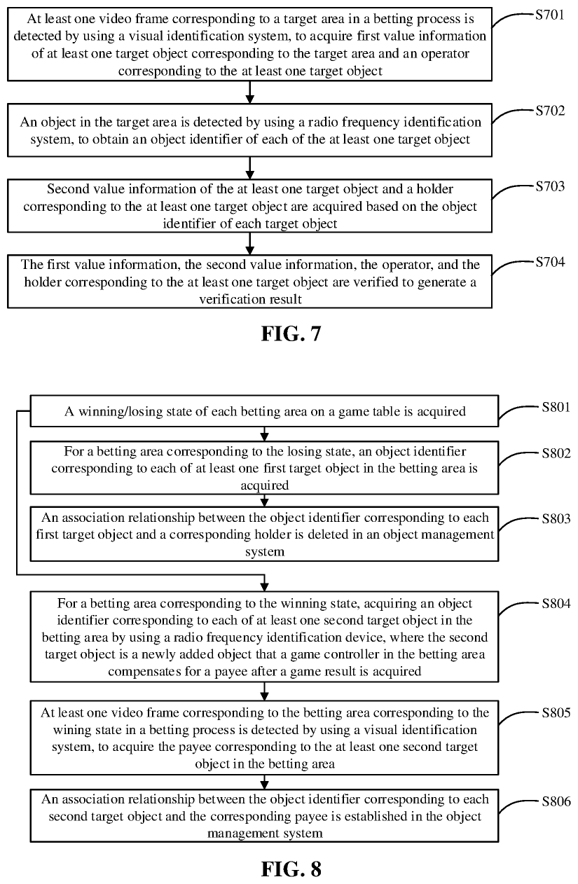

Referring to FIG. 7, FIG. 7 shows a process of verifying object information in a betting stage.

At S701, at least one video frame corresponding to a target area in a betting process is detected by using a visual identification system, to acquire first value information of at least one target object corresponding to the target area and an operator corresponding to the at least one target object.

At S702, an object in the target area is detected by using a radio frequency identification system, to obtain an object identifier of each of the at least one target object.

At S703, second value information of the at least one target object and a holder corresponding to the at least one target object are acquired based on the object identifier of each target object.

At S704, the first value information, the second value information, the operator, and the holder corresponding to the at least one target object are verified to generate a verification result.

Value information and a subject corresponding to the at least one target object need to be separately verified. For example, whether the first value information is the same as the second value information needs to be verified. If the first value information is the same as the second value information, it is determined that the value information of the at least one target object is correctly acquired in the betting process. If the first value information is different from the second value information, it is determined that the value information of the at least one target object is incorrectly acquired in the betting process, and first warning information needs to be sent, where the first warning information is used to instruct a related personnel to verify an actual value of the at least one target object in a betting area. For another example, whether the operator is the same as the holder needs to be verified. If the operator is the same as the holder, it is determined that a using subject of the at least one target object is correctly acquired in the betting process. If the operator is different from the holder, it is determined that a using subject of the at least one target object is incorrectly acquired in the betting process, and second warning information needs to be sent, where the second warning information is used to instruct a related personnel to verify an actual operator of the at least one target object. In some embodiments, the holder and then operator of the at least one target object may be simultaneously displayed on an electronic screen, and the actual operator of the at least one target object is determined from the holder and the operator based on a selection operation performed by the related personnel on the electronic screen.

In some embodiments, the embodiments of the disclosure may be applied to a compensation stage in a game. The foregoing visual identification system is further configured to acquire a game result, where the game result includes a winning/losing state (a failure state or a victory state) of each betting area in a current game table. For a first betting area corresponding to the losing state (the failure state), a mapping relationship between a target object and a holder in the first betting area may be cleared. For a second betting area corresponding to the winning state (the victory state), a mapping relationship between a target object and a holder in the first betting area is maintained, and for a newly added object in the second betting area, a mapping relationship between the newly added object and the holder is established. It is to be noted that before the mapping relationship between the newly added object and the holder is established, in the embodiments of the disclosure, a payee corresponding to the newly added object may be further detected by using the visual identification system. In addition, an object identifier corresponding to the newly added object may be acquired by using the radio frequency identification device. After the payee and the object identifier of the newly added object are obtained, a mapping relationship between the payee and the object identifier is established to implement a compensation process of the game.

Referring to FIG. 8, FIG. 8 shows a changing process of object information in a compensation stage.

At S801, a winning/losing state of each betting area on a game table is acquired.

At S802, for a betting area corresponding to the losing state, an object identifier corresponding to each of at least one first target object in the betting area is acquired.

At S803, an association relationship between the object identifier corresponding to each first target object and a corresponding holder is deleted in an object management system.

At S804, for a betting area corresponding to the winning state, an object identifier corresponding to each of at least one second target object in the betting area is acquired by using a radio frequency identification device, where the second target object is a newly added object that a game controller in the betting area compensates for a payee after a game result is acquired.

At S805, at least one video frame corresponding to the betting area corresponding to the wining state in a betting process is detected by using a visual identification system, to acquire the payee corresponding to the at least one second target object in the betting area.

At S806, an association relationship between the object identifier corresponding to each second target object and the corresponding payee is established in the object management system.

Algorithm design in the embodiments of the disclosure is based on an existing RFID technology and a casino vision technology, and uniqueness of an RFID chip and table top information analyzed by the visual system through deep learning are used to complete an association between a player identity and a bet, and identification of a chip value (value information). This method is well compatible with complex situations such as chip occlusion and standing betting.

FIG. 9 is a schematic structural diagram of composition of an object information management apparatus according to an embodiment of the disclosure. As shown in FIG. 9, an object information management apparatus 900 includes:

a first identification module 901, configured to acquire, in response to an object state change event corresponding to a placement area, at least one object identifier that is obtained by detecting an object in the placement area by using a communication identification system;

a first determination module 902, configured to determine a first identification result based on the at least one object identifier and an object information mapping table, where the object information mapping table includes a mapping relationship between an object identifier and object information, and the first identification result includes first object information of the object in the placement area;

a second identification module 903, configured to acquire a second identification result that is obtained by identifying the object in the placement area by using a visual identification system, where the second identification result includes second object information of the object in the placement area; and

a second determination module 904, configured to determine, based on the first object information and the second object information, real object information corresponding to the object state change event.

In some embodiments, the first object information includes first subject information of a first holder of the object, and the second object information includes second subject information of a second holder of the object; and the second determination module 904 is further configured to: compare the first subject information with the second subject information, and determine a real holder of the object in the placement area based on a comparison result.

In some embodiments, the second determination module 904 is further configured to: if it is determined, based on the comparison result of the first subject information and the second subject information, that the first holder is the same as the second holder, determine that the real holder is the first holder or the second holder; or if it is determined, based on the comparison result of the first subject information and the second subject information, that the first holder is different from the second holder, generate first warning information, where the first warning information is used to indicate that a holder of the object in the placement area is abnormal; and receive a first feedback message for the first warning information, and parse the first feedback message to determine the real holder, where the first feedback message carries manually specified subject information of the real holder of the object in the placement area.

In some embodiments, the first object information includes first value information of the object, and the second object information includes second value information of the object; and the second determination module 904 is further configured to: compare the first value information with the second value information of the object in the placement area, and determine real value information of the object in the placement area based on a comparison result.

In some embodiments, the second determination module 904 is further configured to: if the first value information and the second value information of the object in the placement area are the same, determine that the real value information of the object in the placement area is the first value information or the second value information; or if the first value information and the second value information of the object in the placement area are different, generate second warning information, where the second warning information is used to indicate that value information of the object in the placement area is abnormal and/or the second warning information is used to request to manually adjust the object in the placement area.

In some embodiments, the placement area includes a prop placement area of a game; and the second determination module 904 is further configured to: if it is determined that the game generates a game result, determine an area state corresponding to the prop placement area, where the area state is used to represent a game result of a game party corresponding to the prop placement area; and determine, based on the area state of the prop placement area, the first object information, and the second object information, the real object information corresponding to the object state change event.

In some embodiments, the second determination module 904 is further configured to: if the area state of the prop placement area is a first state, delete a mapping relationship between the at least one object identifier and a corresponding holder from the object information mapping table, where the first state represents that the game result of the game party corresponding to the prop placement area is a failure; or if the area state of the prop placement area is a second state, establish the mapping relationship between the at least one object identifier and the corresponding holder in the object information mapping table, where the second state represents that the game result of the game party corresponding to the prop placement area is a victory.

In some embodiments, the second identification module 903 is further configured to acquire a game result of the game by identifying game props on a game table based on the visual identification system, where the game table includes a plurality of prop placement areas, and the game result includes an area state corresponding to each of the prop placement areas.

In some embodiments, the visual identification system includes a first image capturing device located above the placement area and a second image capturing device located on a side of the placement area, and the second identification module 903 is further configured to: acquire a plurality of image frames corresponding to the object state change event, where the plurality of image frames include at least one top-view image frame of the placement area that is captured by the first image capturing device and at least one side-view image frame of the placement area that is captured by the second image capturing device; and identify the object in the placement area in the plurality of image frames by using the visual identification system, to obtain the second object information.

In some embodiments, if the second object information includes second value information of the object, the second identification module 903 is further configured to: acquire a side image of the object in the placement area based on the at least one side-view image frame; and determine the second value information of the object based on the side image of the object in the placement area.

In some embodiments, if the second object information includes second subject information of a second holder of the object, the second identification module 903 is further configured to: determine an associated image frame from the at least one top-view image frame, where the associated image frame includes an intervening part that has an association relationship with the object in the placement area; determine a target image frame corresponding to the associated image frame from the at least one side-view image frame, where the target image frame includes the intervening part that has an association relationship with the object in the placement area, and at least one intervener; and determine the second subject information of the second holder from the at least one intervener based on the associated image frame and the target image frame.

The descriptions of the foregoing apparatus embodiments are similar to the descriptions of the foregoing method embodiments, and the apparatus embodiments have beneficial effects similar to those of the method embodiments. For technical details not disclosed in the apparatus embodiments of the disclosure, refer to the descriptions of the method embodiments of the disclosure for understanding.

It is to be noted that, in the embodiments of the disclosure, if the foregoing object information management method is implemented in a form of a software function module, and is sold or used as an independent product, the independent product may also be stored in a computer-readable storage medium. Based on such an understanding, the embodiments of the disclosure essentially or the part may be implemented in a form of a software product. The computer software product is stored in a storage medium and includes several instructions for instructing a device to perform all or some of the methods in the embodiments of the disclosure. The storage medium includes any medium that can store program code, such as a USB flash drive, a removable hard disk, a Read Only Memory (ROM), a magnetic disk, or an optical disc. In this way, the embodiments of the disclosure are not limited to any combination of target hardware and software.

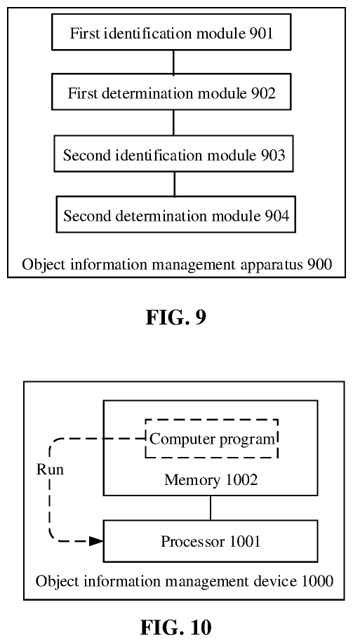

FIG. 10 is a schematic diagram of a hardware entity of an object information management device according to an embodiment of the disclosure. As shown in FIG. 10, a hardware entity of an object information management device 1000 includes a processor 1001 and a memory 1002. The memory 1002 stores a computer program capable of running on the processor 1001, and when the processor 1001 executes the program, the steps in the method in any one of the foregoing embodiments are implemented. In some implementations, the object information management device 1000 for collecting and compensating for a game coin on a game table may be the object information management device described in any one of the foregoing embodiments.

The memory 1002 stores the computer program capable of running on the processor. The memory 1002 is configured to store instructions and an application that can be executed by the processor 1001, and may further cache data (for example, image data, audio data, voice communication data, and video communication data) to be processed or having been processed by modules in the processor 1001 and the object information management device 1000. The data caching may be implemented by using a flash or a Random Access Memory (RAM).

When the processor 1001 executes the program, the steps of any one of the foregoing object information management methods are implemented. The processor 1001 generally controls an overall operation of the object information management device 1000.

The embodiments of the disclosure provide a computer storage medium. The computer storage medium stores one or more programs, and the one or more programs can be executed by one or more processors to implement the steps of the object information management method in any one of the foregoing embodiments.

Herein, it is to be noted here that the descriptions of the foregoing embodiments of the storage medium and the device are similar to the descriptions of the foregoing method embodiments, and the embodiments of the storage medium and the device have similar beneficial effects to the method embodiments. For technical details not disclosed in the embodiments of the storage medium and the device of the disclosure, refer to the descriptions of the method embodiments of the disclosure for understanding.

The processor may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a controller, a microcontroller, or a microprocessor. It may be understood that an electronic component that implements the function of the foregoing processor may be another component, which is not specifically limited in the embodiments of the disclosure.

The computer storage medium/memory may be a memory such as a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, an optical disc, or a Compact Disc Read-Only Memory (CD-ROM), or may be various terminals including one or any combination of the foregoing memories, such as a mobile phone, a computer, a tablet device, and a personal digital assistant.

It is to be understood that “one embodiment”, “an embodiment”, “the embodiments of the disclosure”, “the foregoing embodiments”, or “some embodiments” mentioned throughout the specification mean that target features, structures, or characteristics related to the embodiment are included in at least one embodiment of the disclosure. Therefore, “in one embodiment”, “in an embodiment”, “in the embodiments of the disclosure”, “the foregoing embodiments”, or “some embodiments” throughput the specification do not necessarily mean the same embodiment. In addition, these target features, structures, or characteristics may be combined in one or more embodiments in any appropriate manner. It is to be understood that sequence numbers of the foregoing processes do not mean execution sequences in various embodiments of the disclosure. The execution sequences of the processes should be determined based on functions and internal logic of the processes, and should not be construed as any limitation on the implementation processes of the embodiments of the disclosure. The sequence numbers of the foregoing embodiments of the disclosure are merely for illustrative purposes, and are not intended to indicate priorities of the embodiments.

Unless otherwise specified, that the object information management device performs any step in the embodiments of the disclosure may mean that the processor of the object information management device performs the step. Unless otherwise specified, a sequence in which the object information management device performs the following steps is not limited in the embodiments of the disclosure. In addition, in different embodiments, the same method or different methods may be employed to process data. It is to be further noted that any step in the embodiments of the disclosure may be independently performed by the object information management device, that is, when performing any step in the foregoing embodiments, the object information management device may perform the step without depending on other steps.

In the several embodiments provided in the disclosure, it is to be understood that the disclosed device and method may be implemented in other manners. For example, the described device embodiment is merely an example. For example, the unit division is merely logical function division and may be other divisions in actual implementation. For example, a plurality of units or components may be combined or integrated into another system, or some features may be ignored or not performed. In addition, the displayed or discussed mutual couplings or direct couplings or communication connections between the components may be implemented through some interfaces. The indirect couplings or communication connections between the devices or units may be implemented in electronic, mechanical, or other forms.

The foregoing units described as separate parts may or may not be physically separate, and the parts displayed as units may or may not be physical units; and may be located in one location or distributed on a plurality of network units. Some or all of the units may be selected based on an actual requirement to implement the objectives of the embodiments.

In addition, all functional units in the embodiments of the disclosure may be integrated into one processing unit, or each unit may be separately used as one unit, or two or more units may be integrated into one unit. The foregoing integrated unit may be implemented in a form of hardware, or may be implemented in a form of hardware and a software functional unit.

If no conflict occurs, the methods disclosed in the several method embodiments provided in the disclosure can be arbitrarily combined to obtain new method embodiments.

If no conflict occurs, the features disclosed in the several product embodiments provided in the disclosure can be arbitrarily combined to obtain new product embodiments. If no conflict occurs, the features disclosed in the several method or device embodiments provided in the disclosure can be arbitrarily combined to obtain new method or device embodiments.

A person of ordinary skill in the art may understand that all or some of the steps of the foregoing method embodiments may be implemented by a program instructing relevant hardware. The program may be stored in a computer-readable storage medium. When the program is executed, the steps of the foregoing method embodiments are performed. The foregoing storage medium includes any medium that can store a program code, such as a mobile storage device, a Read Only Memory (ROM), a magnetic disk, or an optical disc.

In an embodiment, when the foregoing integrated unit in the disclosure is implemented in a form of a software functional unit and sold or used as an independent product, the integrated unit may be stored in a computer-readable storage medium. Based on such an understanding, the embodiments of the disclosure may be implemented in a form of a software product. The computer software product is stored in a storage medium, and includes several instructions for instructing a computer device (which may be a personal computer, an object information management device, or a network device) to perform all or some of the steps of the methods in the embodiments of the disclosure. The foregoing storage medium includes any medium that can store program code, such as a mobile storage device, a ROM, a magnetic disk, or an optical disc.

In the embodiments of the disclosure, for descriptions of the same step and the same content in different embodiments, reference may be made to each other. In the embodiments of the disclosure, the term “and” does not affect the sequence of steps.

The foregoing descriptions are merely implementations of the disclosure, but are not intended to limit the protection scope of the disclosure. Any variation or replacement readily figured out by a person skilled in the art within the technical scope disclosed in the disclosure shall fall within the protection scope of the disclosure. Therefore, the protection scope of the disclosure shall be subject to the protection scope of the claims.

What is claimed is:

1. An object information management method, wherein the method comprises:
acquiring, in response to an object state change event corresponding to a placement area, at least one object identifier that is obtained by detecting an object in the placement area by using a communication identification system;
determining a first identification result based on the at least one object identifier and an object information mapping table, wherein the object information mapping table comprises a mapping relationship between an object identifier and object information, and the first identification result comprises first object information of the object in the placement area;
acquiring a second identification result that is obtained by identifying the object in the placement area by using a visual identification system, wherein the second identification result comprises second object information of the object in the placement area; and
determining, based on the first object information and the second object information, real object information corresponding to the object state change event.

2. The method of claim 1, wherein the first object information comprises first subject information of a first holder of the object, and the second object information comprises second subject information of a second holder of the object; and determining, based on the first object information and the second object information, the real object information corresponding to the object state change event comprises:
comparing the first subject information with the second subject information, and determining a real holder of the object in the placement area based on a comparison result.

3. The method of claim 2, wherein the determining the real holder of the object in the placement area based on the comparison result comprises:
in a case of determining, based on the comparison result of the first subject information and the second subject information, that the first holder is the same as the second holder, determining that the real holder is the first holder or the second holder; or
in a case of determining, based on the comparison result of the first subject information and the second subject information, that the first holder is different from the second holder, generating first warning information, wherein the first warning information is used to indicate that a holder of the object in the placement area is abnormal; and
receiving a first feedback message for the first warning information, and parsing the first feedback message to determine the real holder, wherein the first feedback message carries manually specified subject information of the real holder of the object in the placement area.

4. The method of claim 1, wherein the first object information comprises first value information of the object, and the second object information comprises second value information of the object;
wherein determining, based on the first object information and the second object information, the real object information corresponding to the object state change event comprises:
comparing the first value information with the second value information of the object in the placement area, and determining real value information of the object in the placement area based on a comparison result.

5. The method of claim 4, wherein determining the real value information of the object in the placement area based on the comparison result comprises:
in a case where the first value information and the second value information of the object in the placement area are the same, determining that the real value information of the object in the placement area is the first value information or the second value information; or
in a case where the first value information and the second value information of the object in the placement area are different, generating second warning information, wherein the second warning information is used to indicate that value information of the object in the placement area is abnormal and/or the second warning information is used to request to manually adjust the object in the placement area.

6. The method of claim 1, wherein the placement area comprises a prop placement area of a game;
wherein the method further comprises:
in a case of determining that the game generates a game result, determining an area state corresponding to the prop placement area, wherein the area state is used to represent a game result of a game party corresponding to the prop placement area;
wherein determining, based on the first object information and the second object information, the real object information corresponding to the object state change event comprises:
determining the real object information corresponding to the object state change event based on the area state of the prop placement area, the first object information, and the second object information.

7. The method of claim 6, wherein the determining the real object information corresponding to the object state change event based on the area state of the prop placement area, the first object information, and the second object information comprises:
in a case where the area state of the prop placement area is a first state, deleting a mapping relationship between the at least one object identifier and a corresponding holder from the object information mapping table, wherein the first state represents that the game result of the game party corresponding to the prop placement area is a failure; or
in a case where the area state of the prop placement area is a second state, establishing the mapping relationship between the at least one object identifier and the corresponding holder in the object information mapping table, wherein the second state represents that the game result of the game party corresponding to the prop placement area is a victory.

8. The method of claim 6, wherein the method further comprises:
acquiring a game result of the game by identifying a game prop on a game table based on the visual identification system, wherein the game table comprises a plurality of prop placement areas, and the game result comprises an area state corresponding to each of the prop placement areas.

9. The method of claim 1, wherein the visual identification system comprises a first image capturing device located above the placement area and a second image capturing device located on a side of the placement area, and the second identification result is obtained by:
acquiring a plurality of image frames corresponding to the object state change event, wherein the plurality of image frames comprises at least one top-view image frame of the placement area that is captured by the first image capturing device and at least one side-view image frame of the placement area that is captured by the second image capturing device; and
identifying the object in the placement area in the plurality of image frames by using the visual identification system, to obtain the second object information.

10. The method of claim 9, wherein in a case where the second object information comprises second value information of the object, identifying the object in the placement area in the plurality of image frames by using the visual identification system, to obtain the second object information comprises:
acquiring a side image of the object in the placement area based on the at least one side-view image frame; and
determining the second value information of the object based on the side image of the object in the placement area.

11. The method of claim 9, wherein in a case where the second object information comprises second subject information of a second holder of the object, identifying the object in the placement area in the plurality of image frames by using the visual identification system, to obtain the second object information comprises:
determining an associated image frame from the at least one top-view image frame, wherein the associated image frame comprises an intervening part that has an association relationship with the object in the placement area;
determining a target image frame corresponding to the associated image frame from the at least one side-view image frame, wherein the target image frame comprises the intervening part that has an association relationship with the object in the placement area, and at least one intervener; and
determining the second subject information of the second holder from the at least one intervener based on the associated image frame and the target image frame.

12. An object information management device, comprising a memory and a processor,
wherein the memory stores a computer program capable of running on the processor;
wherein when executing the computer program, the processor is configured to:
acquire, in response to an object state change event corresponding to a placement area, at least one object identifier that is obtained by detecting an object in the placement area by using a communication identification system;
determine a first identification result based on the at least one object identifier and an object information mapping table, wherein the object information mapping table comprises a mapping relationship between an object identifier and object information, and the first identification result comprises first object information of the object in the placement area;
acquire a second identification result that is obtained by identifying the object in the placement area by using a visual identification system, wherein the second identification result comprises second object information of the object in the placement area; and
determine, based on the first object information and the second object information, real object information corresponding to the object state change event.

13. The device of claim 12, wherein the first object information comprises first subject information of a first holder of the object, and the second object information comprises second subject information of a second holder of the object; wherein when determining, based on the first object information and the second object information, the real object information corresponding to the object state change event, the processor is configured to:
compare the first subject information with the second subject information, and determine a real holder of the object in the placement area based on a comparison result.

14. The device of claim 13, wherein when determining the real holder of the object in the placement area based on the comparison result, the processor is configured to:
in a case of determining, based on the comparison result of the first subject information and the second subject information, that the first holder is the same as the second holder, determine that the real holder is the first holder or the second holder; or
in a case of determining, based on the comparison result of the first subject information and the second subject information, that the first holder is different from the second holder, generate first warning information, wherein the first warning information is used to indicate that a holder of the object in the placement area is abnormal; and
receive a first feedback message for the first warning information, and parse the first feedback message to determine the real holder, wherein the first feedback message carries manually specified subject information of the real holder of the object in the placement area.

15. The device of claim 12, wherein the first object information comprises first value information of the object, and the second object information comprises second value information of the object;
wherein when determining, based on the first object information and the second object information, the real object information corresponding to the object state change event, the processor is configured to:
compare the first value information with the second value information of the object in the placement area, and determine real value information of the object in the placement area based on a comparison result.

16. The device of claim 15, wherein when determining the real value information of the object in the placement area based on the comparison result, the processor is configured to:
in a case where the first value information and the second value information of the object in the placement area are the same, determine that the real value information of the object in the placement area is the first value information or the second value information; or
in a case where the first value information and the second value information of the object in the placement area are different, generate second warning information, wherein the second warning information is used to indicate that value information of the object in the placement area is abnormal and/or the second warning information is used to request to manually adjust the object in the placement area.

17. The device of claim 12, wherein the placement area comprises a prop placement area of a game;
wherein the processor is further configured to:
in a case of determining that the game generates a game result, determine an area state corresponding to the prop placement area, wherein the area state is used to represent a game result of a game party corresponding to the prop placement area;
wherein when determining, based on the first object information and the second object information, the real object information corresponding to the object state change event, the processor is configured to:
determine the real object information corresponding to the object state change event based on the area state of the prop placement area, the first object information, and the second object information.

18. The device of claim 17, wherein when determining the real object information corresponding to the object state change event based on the area state of the prop placement area, the first object information, and the second object information, the processor is configured to:
in a case where the area state of the prop placement area is a first state, delete a mapping relationship between the at least one object identifier and a corresponding holder from the object information mapping table, wherein the first state represents that the game result of the game party corresponding to the prop placement area is a failure; or
in a case where the area state of the prop placement area is a second state, establish the mapping relationship between the at least one object identifier and the corresponding holder in the object information mapping table, wherein the second state represents that the game result of the game party corresponding to the prop placement area is a victory.

19. The device of claim 17, wherein the processor is further configured to:
acquire a game result of the game by identifying a game prop on a game table based on the visual identification system, wherein the game table comprises a plurality of prop placement areas, and the game result comprises an area state corresponding to each of the prop placement areas.

20. A nonvolatile computer readable storage medium, wherein the nonvolatile computer storage medium stores at least one program, and the at least one program, when executable by at least one processor, is configured to:
acquire, in response to an object state change event corresponding to a placement area, at least one object identifier that is obtained by detecting an object in the placement area by using a communication identification system;
determine a first identification result based on the at least one object identifier and an object information mapping table, wherein the object information mapping table comprises a mapping relationship between an object identifier and object information, and the first identification result comprises first object information of the object in the placement area;
acquire a second identification result that is obtained by identifying the object in the placement area by using a visual identification system, wherein the second identification result comprises second object information of the object in the placement area; and
determine, based on the first object information and the second object information, real object information corresponding to the object state change event.
